(19) United States
(12) Patent Application Publication
(10) Pub. No.: US 2008/0203915 A1
(43) Pub. Date: Aug. 28, 2008

(54) MATERIAL OF PROTECTIVE LAYER, METHOD OF PREPARING THE SAME, PROTECTIVE LAYER FORMED OF THE MATERIAL, AND PLASMA DISPLAY PANEL INCLUDING THE PROTECTIVE LAYER

(75) Inventors: Min-Suk Lee, Suwon-si (KR); Yury Matulevich, Suwon-si (KR); Suk-ki Kim, Suwon-si (KR); Jong-Seo Choi, Suwon-si (KR); Young-Su Kim, Suwon-si (KR); Hee-Young Chu, Suwon-si (KR); Deok-Hyun Kim, Suwon-si (KR); Soon-Sung Suh, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/017,466

(22) Filed: Jan. 22, 2008

(30) Foreign Application Priority Data
Feb. 28, 2007 (KR) 2007-20545

(51) Int. Cl. H01J 17/49

(52) U.S. Cl. 313/586

(57) ABSTRACT

A material for preparing a protective layer for a PDP, which reduces discharge delay time, improves temperature dependency, and has enhanced ion strength; a method of preparing the same; a protective layer formed of the material; and a PDP including the protective layer. More particularly, a material for a protective layer that includes monocrystalline magnesium oxide doped with a rare earth element at an amount of 2.0×10−5−1.0×10−2 parts by weight per 1 part by weight of magnesium oxide (MgO), a method of preparing the monocrystalline magnesium oxide by crystallizing it at about 2,800° C., a protective layer formed of the same, and PDP including the protective layer.

### CROSS-REFERENCE TO RELATED PATENT APPLICATIONS

This application claims the benefit of Korean Patent Application No. 2007-20545, filed Feb. 28, 2007, in the Korean Intellectual Property Office, the disclosure of which is incorporated herein in its entirety by reference.

### BACKGROUND OF THE INVENTION

1. Field of the Invention

Aspects of the present invention relate to a material for preparing a protective layer of a plasma display panel that has reduced discharge delay time, improved temperature dependency, and enhanced ion strength, a method of preparing the same, a protective layer formed of the material and a plasma display panel including the protective layer.

2. Description of the Related Art

Plasma display panels (PDPs) can be easily used to form large screens, and have good display qualities due to their self-emission and quick response. In addition, PDPs can be formed in thin films, and thus, like LCDs, are suitable for wall-mounted displays.

FIG. 1 illustrates one PDP pixel among the hundreds of thousands which make up a PDP. Referring to FIG. 1, a pair of sustain electrodes each include a transparent electrode 15a paired with a metal bus electrode 15b, and are formed on a surface of a front substrate 14 between the front substrate 14 and a rear substrate 10. A dielectric layer 16 is disposed on the surface of the front substrate 14 between the front substrate 14 and the rear substrate 10 to cover the pairs of sustain electrodes. The dielectric layer 16 is covered by a protective layer 17 so as to maintain the discharge characteristics and extend the lifetime of the dielectric layer 16.

An address electrode 11, covered by a dielectric layer 12, is formed on a surface of the rear substrate 10 between the front substrate 14 and the rear substrate 10. The front substrate 14 is separated from the rear substrate 10, and the space between is filled with a discharge gas, such as Ne or the like, that generates ultraviolet rays.

The protective layer 17 gives the following advantages.

First, the protective layer 17 protects the transparent and bus electrodes 15a and 15b and the dielectric layer 16. Even if only the transparent and bus electrodes 15a and 15b are formed on the front substrate or if the dielectric layer 16 is formed to cover the transparent and bus electrodes 15a and 15b, discharge can still occur. However, when only the transparent and bus electrodes 15a and 15b are formed on the front substrate 10, the discharged current is difficult to control. Also, when only the dielectric layer 16 is formed to cover the transparent and bus electrodes 15a and 15b with no protective layer 17, the dielectric layer 16 can be damaged by sputtering etching from the bombardment of energized ions. Therefore, the dielectric layer 16 is coated with a protective layer 17 that has a strong resistance to plasma ions.

Second, the protective layer 17 decreases a discharge starting voltage. A secondary electron emission coefficient is a physical value of a material for forming a protective layer and is directly related to the discharge starting voltage. As more secondary electrons are emitted from the protecting layer, the discharge starting voltage drops. Thus, it is desirable that the material for forming the protective layer has a high secondary electron emission coefficient.

Finally, the protective layer 17 decreases a discharge delay time. The discharge delay time measures the delay between when a voltage is applied and when discharge occurs, and is the sum of a formation delay time (Tf) and a statistical delay time (Ts). The Tf is a time interval between an applied voltage and a discharge current, and the Ts is a statistical dispersion of the formation delay time. As the discharge delay time decreases, high speed addressing can be attained and thus a single scan can be used. Also, scan drive requirements can be reduced, and more subfields can be formed. Thus, the PDP can have high brightness and image quality.

At present, two types of magnesium oxide are used as the raw material of a protective layer of a PDP: a monocrystalline and a polycrystalline. When the two raw materials are transferred to a thin film formed on a dielectric layer using a vacuum deposition method, such as plasma evaporation or e-beam evaporation, a protective layer is formed of polycrystalline magnesium oxide regardless of the state of the raw material. However, there is a big difference between the polycrystalline protective layer and the polycrystalline raw material. In the case of the former (i.e., the polycrystalline protective layer), the grain and void size are small, the configuration of the grain is relatively constant, and the thickness is small so that the light transmission is about 80-90%. In the case of the latter (i.e., the polycrystalline raw material), the grain and void size are large, the grain is randomly oriented, and the thickness of the polycrystalline raw material is large so that the polycrystalline raw material is opaque.

FIG. 2 includes a graph 1 showing the discharge delay time of a protective layer formed using monocrystalline magnesium oxide and a graph 2 showing the discharge delay time of a protective layer formed using polycrystalline magnesium oxide. Referring to the graph 1, the temperature dependency is relatively low, but the discharge delay time of the protective layer formed using monocrystalline magnesium oxide is high such that single scan operation cannot be used.

Therefore, recent research on applying polycrystalline magnesium oxide to a protective layer of a PDP rather than monocrystalline magnesium oxide has been reported. Referring to FIG. 2, while monocrystalline magnesium oxide has low dependency on temperature, it can not achieve the discharge delay time that is required for single scan operation. However, polycrystalline magnesium oxide has a fast discharge delay time at high temperatures and a slow discharge delay time at low temperatures. In addition, the protective layer using polycrystalline magnesium oxide has relative advantages in terms of a preparation process and impurity adjustment over the protective layer using monocrystalline magnesium. Also, since polycrystalline magnesium oxide has a higher deposition speed than monocrystalline magnesium oxide, a process index can be decreased and the speed with which the PDPs are produced can increase. However, a protective layer using monocrystalline magnesium oxide needs an Xe content of less than 10%, otherwise a severely low discharge occurs and image transmission is may not be possible.

However, polycrystalline magnesium oxide is not a perfect material for a protective layer of a PDP. During discharge, the temperature of the discharge spaces increase, which decreases the discharge delay time, but discharge may be excessive and low. Therefore, when gradation is increased, discharge delay time and temperature dependency on the discharge delay time are changed such that unstable discharge occurs. In particular, polycrystalline magnesium oxide has a more severe discharge index as more discharge drift occurs when the discharge delay time and the discharge initiation voltage are varied. This may be because the polycrystalline material has a relatively weak membrane strength with respect to ions compared with the monocrystalline material.

### SUMMARY OF THE INVENTION

Aspects of the present invention provide a material for preparing a protective layer of a PDP, which reduces discharge initiation voltage and temperature dependency with respect to discharge delay time, and a method of preparing the same.

Aspects of the present invention also provide a PDP having enhanced reliability and productivity using the material for a protective layer.

According to an aspect of the present invention, there is provided a material for preparing a protective layer of a plasma display panel comprising monocrystalline magnesium oxide doped with a rare earth element at an amount of 2.0×10⁻⁵−1.0×10⁻² parts by weight per 1 part by weight of magnesium oxide (MgO).

The monocrystalline magnesium oxide has a crystal plane of (1,0,0).

The rare earth element is one selected from the group consisting of Sc, Y, La, Ce, Pr, Nd, Sm, Eu, Gd, Tb, Dy, Ho, Er, Tm, Yb and Lu.

The material for preparing a protective layer of a PDP further comprises at least one element selected from the group consisting of Al, Ca, Fe, Si, K, Na, Zr, Mn, Cr, Zn, B and Ni.

According to another aspect of the present invention, there is provided a method of preparing a material used to form a protective layer of a PDP comprising: forming a mixed solution of MgO or a magnesium salt, a rare earth oxide (M₂O₃) or a rare salt, and a solvent; calcinating the solution; and crystallizing the calcinated solution to form monocrystalline magnesium oxide doped with a rare earth element.

The magnesium salt is one selected from the group consisting of MgCO₃ and Mg(OH)₂.

The rare earth salt is one selected from the group consisting of M(NO₃)₃, M₂(SO₄)₃ and MCl₃, in which M is a rare earth element.

The solution further comprises MgF₂ and MF₃, in which M is a rare earth element, as a fluxing agent.

The method of preparing a material used to form a protective layer of a PDP further comprises drying the solution. The drying process removes H₂O and can be performed prior to the calcination process.

The calcinating of the solution is performed at 400-1,000° C., and removes OH.

The crystallizing of the calcinated solution can be performed at 2,000-3,000° C. After the crystallization process, the monocrystalline magnesium oxide is composed of an amorphous region, a polycrystalline region and a monocrystalline region, and the monocrystalline region is extracted to be used as a material for preparing a protective layer.

The rare earth element is one selected from the group consisting of Sc, Y, La, Ce, Pr, Nd, Sm, Eu, Gd, Tb, Dy, Ho, Er, Tm, Yb and Lu.

According to another aspect of the present invention, there is provided a protective layer of a PDP, which is deposited using the monocrystalline magnesium oxide doped with a rare earth element.

The rare earth element is one selected from the group consisting of Sc, Y, La, Ce, Pr, Nd, Sm, Eu, Gd, Tb, Dy, Ho, Er, Tm, Yb and Lu.

The monocrystalline magnesium oxide doped with a rare earth element can further comprise at least one element selected from the group consisting of Al, Ca, Fe, Si, Na, Zr, Mn, Cr, Zn, B, Ni and the like.

The monocrystalline magnesium oxide doped with a rare earth element is formed by calcinating and crystallizing a mixed solution of MgO or a magnesium salt, a rare earth oxide (M₂O₃, in which M is a rare earth element) or a rare earth salt, and a solvent.

According to another aspect of the present invention, there is provided a plasma display panel comprising: a first substrate and second substrate that are separated from each other; barrier ribs that form a plurality of discharge cells by dividing a discharge space between the first substrate and the second substrate; a plurality of discharge electrode pairs to which a voltage is applied in order to generate discharge in the discharge cells; a discharge gas that is injected into the discharge space; an first dielectric layer covering the discharge electrode pairs; and a protective layer that is formed on the first dielectric layer, and formed of a monocrystalline magnesium oxide doped with a rare earth element.

The monocrystalline magnesium oxide doped with a rare earth element is formed by calcinating and crystallizing a mixed solution of MgO or a magnesium salt, a rare earth oxide (M₂O₃, in which M is a rare earth element) or a rare earth salt, and a solvent. The rare earth element is one selected from the group consisting of Sc, Y. La, Ce, Pr, Nd, Sm, Eu, Gd, Tb, Dy, Ho, Er, Tm, Yb and Lu. The monocrystalline magnesium oxide doped with a rare earth element can further comprise at least one element selected from the group consisting of Al, Ca, Fe, Si, K, Na, Zr, Mn, Cr, Zn, B, Ni and the like.

The discharge gas comprises Xe and He, or Xe, He and Ne. The amount of Xe may be 10-100 volume % based on the total volume of the discharge gas in order to improve the luminance of a phosphor by increasing a molecular beam.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of a conventional plasma display panel (PDP) in which a first substrate or a second substrate is rotated by 90°;

FIG. 2 is a graph showing discharge delay time with respect to temperature of monocrystalline magnesium oxide that is not doped with a rare earth element;

FIG. 3 is a schematic view illustrating an Auger neutralization theory describing emission of an electron from a solid by a gas ion;

FIG. 4 is an exploded perspective view of a PDP including a protective layer according to aspects of the present invention;

FIGS. 5 through 7 are images showing results of measuring ion strength of protective layers formed using monocrystalline magnesium oxide that is not doped with rare earth elements, a protective layer according to aspects of the present invention, and polycrystalline magnesium oxide that is not doped with rare earth elements, as a deposition source;

FIG. 8 is a graph showing the decrease in discharge initiation voltage of a PDP including a protective layer according to aspects of the present invention; and

FIG. 9 is a graph showing the decrease in discharge delay time and improvement in temperature dependency of a PDP including a protective layer according to aspects of the present invention.

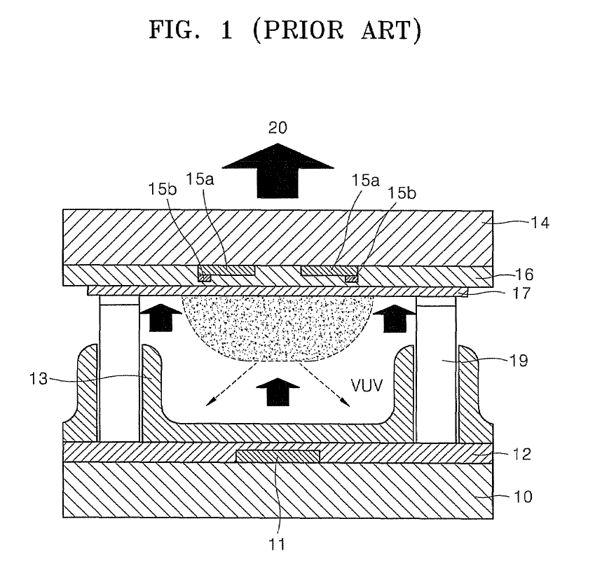

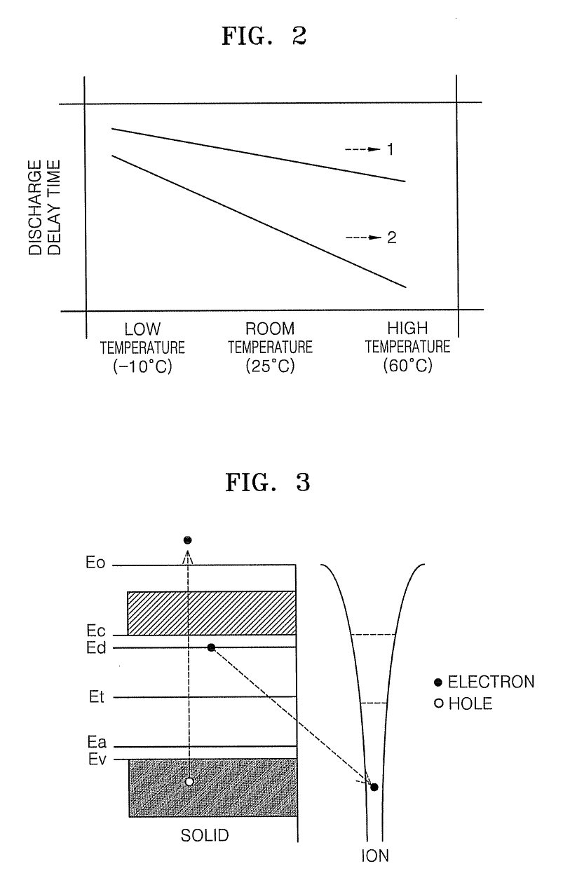

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A protective layer of a PDP according to aspects of the present invention has three relevant physical properties: a bulk physical property, a surface physical property, and a grain boundary physical property. The grain boundary is formed by out-diffusion or segregation between elements of MgO and a material included in polycrystalline magnesium oxide (hereinafter, referred to as ‘doping impurities’). Components existing in the grain boundary show a difference in their state and electrical properties according to the type of doping impurities. For example, when MgO is considerably doped with silicon (Si), a glass state or non-crystalline state at the grain boundary becomes dominant. In addition, silicon (Si) itself has a high electron affinity, so the silicon (Si) does not contribute to secondary electron emissions as the silicon (Si) forms a negative space charge as the silicon (Si) facilitates neutralization of holes formed by the secondary electron emissions. Therefore, a glass state at the grain boundary is not formed. Furthermore, doping impurities that do not form negative space charges are advantageous to discharge.

An MgO ion has a six-coordinate octahedral structure and a radius of 86 pm. Therefore, a doping impurity with which Mg of MgO having a six-coordinate octahedral structure and a radius of 86 pm is substituted is required, and a doping impurity that is not mixed with MgO due to a difference in surface energy therebetween, thereby not being concentrated in a grain boundary is needed.

Referring to Table 1, rare earth elements have low electron affinity, and thus benefit the discharge properties of the protective layer.

TABLE 1

| | Element | | | | | | | | | | | | | | | |
|---|---|---|---|---|---|---|---|---|---|---|---|---|---|---|---|---|
| | Sc | Y | La | Ce | Pr | Nd | Sm | Eu | Gd | Tb | Dy | Ho | Er | Tm | Yb | Lu |
| Electron | 0.19 | 0.3 | 0.53 | 0.5 | 0 | <0 | 0.3 | <0 | 0.5 | 0.5 | <0 | <0 | <0 | 0.3 | <0 | 0.5 |
| affinity (eV) | | | | | | | | | | | | | | | | |
| Radius (pm) | 88 | 104 | 117 | 115 | 133 | 112 | 110 | 109 | 108 | 106 | 105 | 104 | 103 | 102 | 101 | 100 |

In addition, since the oxidation numbers of the rare earth elements are generally +3, to form an N-type magnesium oxide having an increased number of negative charge carriers, the rare earth element is doped on the protective layer.

The protective layer according to aspects of the present invention can be described by an Auger neutralization theory. According to the Auger neutralization theory, when a discharge gas ion collides with a solid, which is the protective layer, an electron moves from the solid to the discharge gas ion so that a neutral gas is generated and electrons escape from the solid to a vacuum in which the discharge gas is disposed to form holes. This relationship can be represented by Equation 1 below:

Eₖ=E_{I}−2(E_{g}+X) Equation 1

In Equation 1, Eₖ is an energy generated when an electron is emitted from the solid, E_{I} is an ionization energy of a gas, E_{g} is a band gap energy of the solid, and X is electron affinity.

It is reported that the emission coefficient of secondary electron of a material becomes higher as Eₖ in Equation 1 increases. Eₖ is experimentally obtained. Therefore, E_{g}, which is the band gap energy of a protective layer, can be reduced using doping impurities.

In more detail, referring to FIG. 3, the solid, which is the protective layer, forms a donor level (Ed), an acceptor level (Ea), and a deep level (Et), between a valence band (Ev) and a conduction band (Ec). The protective layer is doped with rare earth elements having an oxidation number of +3. Therefore, when a discharge gas ion collides with the protective layer, electrons in the donor level (Ed) of the solid move to the discharge gas ion. More specifically, electrons are transferred from the solid protective layer to the discharge gas ion while transferring energy via the Auger effect to another electron, which is then ejected into the discharge cell. Accordingly, a band gap shrinkage effect can be obtained by the doping of the MgO, in which Mg has an oxidation number of +2, with a dopant that has an oxidation number of +3.

To form the donor level between band gaps of MgO, the doping uses an element that has a larger oxidation number than Mg, which is +2, for example, Al having an oxidation number of +3. In addition, when the doping element has a smaller oxidation number than Mg, for example, Li having an oxidation number of +1, the acceptor level is formed. However, E-beam deposition is not suitable for preparing a p-type MgO protective layer by doping with Li. In addition, there are not many types of materials for P-type doping while there are relatively many N-type doping impurities. Further, P-type doping is difficult.

In addition, the binding energy of electrons in a donor or binding level (Ed of FIG. 3) is weaker and in a higher energy state than the electrons in a valence band (Ev) meaning that the electrons in the donor level (Ed) are more easily removed as the electrons are more energetic. Therefore, secondary electron emission due to gas ion neutralization is improved, and exo-electron emission is more easily effected.

As a result, the rare earth element doped protective layer according to aspects of the present invention can promptly emit a large amount of electrons because the protective layer is doped with N-type rare earth doping impurities, which are easily obtained and deposited, and provide electrons in a donor level.

As described above, discharge initiation voltage is reduced by doping the protective layer according to aspects of the present invention with rare earth doping impurities, which increases secondary electron emission. However, the doping impurities can further comprise other metals having the same oxidation number as Mg²⁺ in addition to the rare earth elements.

Of the rare earth elements shown in Table 1, when MgO is doped with Sc, Mg²⁺ is substituted with Sc³⁺ and another Mg defect occurs in order to maintain electrical neutralization. Sc³⁺ forms a donor level and the Mg defect forms an acceptor level. Such is because N-type doping impurities in the protective layer cause the protective layer to form a donor level (electron trap) and also form an acceptor level (hole trap). However, the ratio of the donor level and the acceptor level depends on the doping impurities.

P-type doping impurities mainly form an acceptor level. However, to maintain electrical neutrality, an oxygen defect is generated and the P-type doping impurities in the protective layer cause the protective layer to additionally form a donor level. When an element having the same electron valence as Mg²⁺, for example, Ca²⁺, is doped, no difference occurs between the electron valences. However, since there is a difference in an ion radius and the states of binding with oxygen between Mg²⁺ and Ca²⁺, lattice distortion is generated such that an acceptor level can be formed. The acceptor level is less related to electron emission and forms a positive surface thereby preventing the motion of wall charges formed on a surface after a discharge. The motion of wall charges can occur due to a partial difference in temperature or strength of an electric field. When the motion of wall charges is severe, such motion can affect an address period that selects discharge cells to be turned on. Therefore, the severe motion of wall charges can lead to low discharge caused by address failure of the discharge cells. In particular, partial low discharge or excessive discharge occurs severely at high temperatures or a high gray scale. Partial low discharge or excessive discharge may occur due to the loss of wall charges.

Therefore, when an N-type doping impurity is injected, donor and acceptor levels are formed. However, since the amount thereof is generally small, a doping impurity having the same electron valence as the N-type doping impurity is doped together in order to form a lot of acceptor levels.

The formation of the above described protective layer is described as follows: 1 kg of magnesium oxide (MgO) powder having a particle size of 0.5 μm was mixed with 2 L of an ethanol solvent, and then 0.613 g of SC₂O₃, which is a rare earth salt, was added to prepare a sample. Then, the sample was dried and calcinated. The drying process was performed by removing a moisture component, such as H₂O, from Mg(OH)₂ existing in the MgO powder, and the calcination process was performed by removing OH⁻. These processes help oxidation of the rare earth salt and the reaction of the rare earth salt and MgO. The drying and calcination processes were performed at about 400-1,000° C. for 10 hours or less. Subsequently, the calcinated sample was crystallized at a temperature of about 2,800° C. The heat energy needed for the crystallization was provided by an arc discharge of a carbon rod, and a conventional arc furnace was used. The crystallized sample was divided into three regions: a polycrystalline region, a monocrystalline region and a region similar to the raw material. Of such regions, the monocrystalline region was extracted and cut to a dimension of 2-5 mm to complete a material used to form a protective layer.

The prepared monocrystalline magnesium oxide may have a crystal plane of (1,0,0) as shown by X-ray analysis. The crystal plane has Miller indices of (1,0,0) meaning that, within the crystal structure, molecules are arranged at least in a lattice plane normal to the direction (1,0,0). In addition, the monocrystalline magnesium oxide comprises other metals selected from the group consisting of Al, Ca, Fe, Si, K, Na, Zr, Mn, Cr, Zn, B, Ni and the like, in addition to rare earth elements.

The material for preparing a protective layer comprises monocrystalline magnesium oxide in which a rare earth element is doped in the magnesium oxide (MgO). A protective layer of a plasma display panel (PDP) that is formed using this material comprises polycrystalline magnesium oxide doped with the rare earth element, and the protective layer is also doped with the rare earth element.

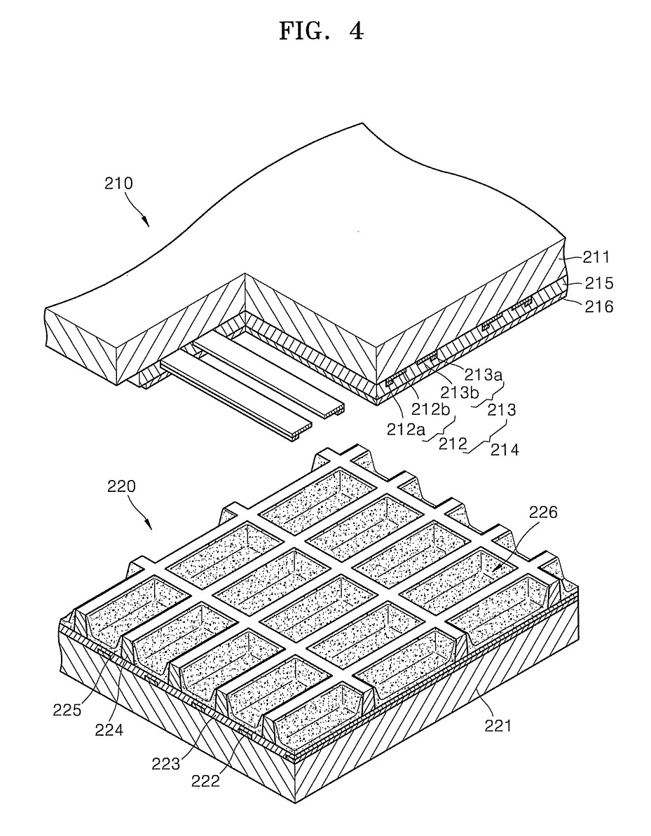

FIG. 4 is an exploded perspective view of a PDP including a protective layer according to aspects of the present invention. Referring to FIG. 4, the PDP includes a front panel 210 and a rear panel 220. The front panel 210 includes a first substrate 211, discharge electrode pairs 214, a first dielectric layer 215, and a protective layer 216.

The first substrate 211 may be formed of a material having good light transmission, for example, a glass substrate. In addition, the first substrate 211 can be colored in order to improve light room contrast by reducing reflection of external light.

A plurality of discharge electrode pairs 214 are formed on the first substrate 211 disposed between the first substrate 211 and the rear panel 220. The discharge electrode pairs 214 each include an X electrode 212 and a Y electrode 213. The X electrode 212 includes an X bus electrode 212a and an X transparent electrode 212b. The Y electrode 213 includes a Y bus electrode 213a and a Y transparent electrode 213b.

The X bus electrode and Y bus electrode 212a and 213a compensate for the relatively high resistance of the X transparent electrode and Y transparent electrode 212b and 213b to apply almost the same voltage to a plurality of discharge cells. For example, the X bus electrode and the Y bus electrode 212a and 213a can be formed of Cr, Cu, Al, or the like.

The X transparent electrode and the Y transparent electrode 212b and 213b generate and sustain discharge and can be formed of a material having high visible light transmission and low electrical resistance, for example indium tin oxide (ITO), or the like.

The first dielectric layer 215 sustains glow discharge by limiting discharge current, and reduces a memory function and voltage by wall charge accumulation. In addition, the first dielectric layer 215 may have a high dielectric withstanding voltage (DWV) and visible light transmission so as to increase discharge efficiency.

The protective layer 216 protects the first dielectric layer 215 and the discharge electrode pairs 214 from the collision of discharge particles, and reduces the discharge initiation voltage by increasing the secondary electron emission coefficient. The protective layer 126 according to aspects of the present invention is deposited on the first dielectric layer 215 and formed of polycrystalline MgO doped with a rare earth element.

The protective layer is formed by calcinating a mixed solution of MgO or magnesium salts, a rare earth oxide (M₂O₃, in which M is a rare earth element) or rare earth salts, and a solvent, and then crystallizing the resultant at about 2,000-3,000° C. and applying the obtained monocrystalline magnesium oxide to the first dielectric layer 215. The mixed solution may also contain MgF₂ and/or MF₃, in which M is a rare earth element, as a fluxing agent.

The magnesium salts can be MgCO₃, Mg(OH)₂ or the like. The rare earth salts can be M(NO₃)₃, M₂(SO₄)₃, or MCl₃, in which M is a rare earth element, such as Sc, Y, La, Ce, Pr, Nd, Sm, Eu, Gd, Tb, Dy, Ho, Er, Tm, Yb or Lu.

The monocrystalline magnesium oxide obtained by the method described above is a material for preparing a protective layer, is doped with a rare earth element at about 2.0×10⁻5−1.0×10⁻² parts by weight per 1 part by weight of MgO and has a crystal plane of (1,0,0).

The monocrystalline magnesium oxide can further include Al, Ca, Fe, Si, K, Na, Zr, Mn, Cr, Zn, B, Ni or the like.

The monocrystalline magnesium oxide that is used as a source is deposited on the first dielectric layer 215 to form the protective layer 216. This deposition can be performed by chemical vapor deposition (CVD), E-beam deposition, ion-plating, sputtering or the like.

The rear panel 220 includes a second substrate 221, address electrodes 222, a second dielectric layer 223, barrier ribs 224 and phosphor layers 225.

The second substrate 221 may formed of a material having good light transmission, for example, a glass substrate, like the first substrate 211. In addition, the second substrate 221 can be colored in order to improve light room contrast by reducing reflection of external light.

The first substrate 211 and the second substrate 221 are separated from each other to form discharge space, and the discharge space is divided into a plurality of discharge cells 226 by the barrier ribs 224. The barrier ribs 224 are illustrated as being arranged in a matrix, but are not limited thereto. The barrier ribs 224 can also have various forms such as a stripe-type, a hive-type or the like. Furthermore, the discharge cells 226 may have different shapes, such as circular or polygonal.

The address electrodes 222 are formed on a surface of the second substrate 221 disposed between the first and the second substrates 220 and 221, and the address electrodes 222 can be formed of Cr, Cu, Al or the like, that has high electrical conductivity. The address electrodes 222 have a high electrical conductivity (or low electrical resistance) so as to apply almost the same voltage to a plurality of discharge cells 226, similar to the bus electrodes 212a and 213a as described above.

The second dielectric layer 223 protects the address electrodes 222 from the collision of discharge particles. In addition, the second dielectric layer 223 has high insulation strength, and when the PDP is a front emission type, is formed of a material having high photoreflectance to thereby enhance emission efficiency.

Phosphor layers 225 are formed on the second dielectric layer 223 and the barrier ribs 224. The phosphor layers 225 are formed in different colors for a full-color display. For example, when color imaging is implemented using three colors of light, red, green, and blue phosphors are alternately coated in the plurality of discharge cells 226. According to a type of phosphor layers 225 coated in each discharge cell 226, red, green, or blue monochromatic light is emitted, and the colors combine to form color images.

A discharge gas is injected into the plurality of discharge cells 226. The discharge gas can be an inert gas such as Ne, Xe, or He, or a mixture thereof.

The Auger neutralization theory and Equation 1 can be applied to the protective layer 216 of a PDP according to aspects of the present invention and the discharge gas. When a voltage is applied to the discharge cells 226, seed electrons generated from ultraviolet rays collide with discharge gas to form discharge gas ions, and the discharge gas ions collide with the protective layer so that secondary electrons are emitted from the protective layer. As a result, discharge is generated.

Table 2 shows various inert gases used as discharge gases and their resonant emission wavelengths and ionization voltages. The protective layer is formed of MgO, and thus in Equation 1, the band gap energy E_{g} of the protective layer is 7.7 eV, which is the band gap energy of MgO, and the electron affinity X thereof is 0.5.

TABLE 2

| | | | | Metastable level | | Ionization |
|---|---|---|---|---|---|---|
| | Resonance level excitation | | | excitation | | voltage |
| Gas | Voltage (V) | Wavelength (nm) | lifetime (ns) | Voltage (V) | lifetime (ns) | Voltage (V) |
| He | 21.2 | 58.4 | 0.555 | 19.8 | 7.9 | 24.59 |
| Ne | 16.54 | 74.4 | 20.7 | 16.62 | 20 | 21.57 |
| Ar | 11.61 | 107 | 10.2 | 11.53 | 60 | 15.76 |
| Kr | 9.98 | 124 | 4.38 | 9.82 | 85 | 14.0 |
| Xe | 8.45 | 147 | 3.79 | 8.28 | 150 | 12.13 |

Meanwhile, to increase light conversion efficiency of phosphors of PDPs, the discharge gas may be Xe, which generates vacuum ultraviolet rays having the longest wavelength, and Xe may be included in an amount of 10% or more based on the total volume of the discharge gas. However, the ionization voltage of Xe, that is, the ionization energy E_{I}, is 12.13 eV, and when this is substituted into Equation 1, the energy Eₖ generated when an electron is emitted is less than 0. Therefore, the discharge initiation voltage becomes very high.

Accordingly, when Xe is used as a discharge gas, another gas having a high ionization voltage has to be used in order to reduce the discharge initiation voltage. According to Equation 1, He has an Eₖ of 8.19 eV and Ne has an Eₖ of 5.17 eV, so He or Ne may be used in order to reduce the discharge initiation voltage. Therefore, the discharge gas can be a first mixed gas of Xe and He or a second mixed gas of Xe, He, and Ne.

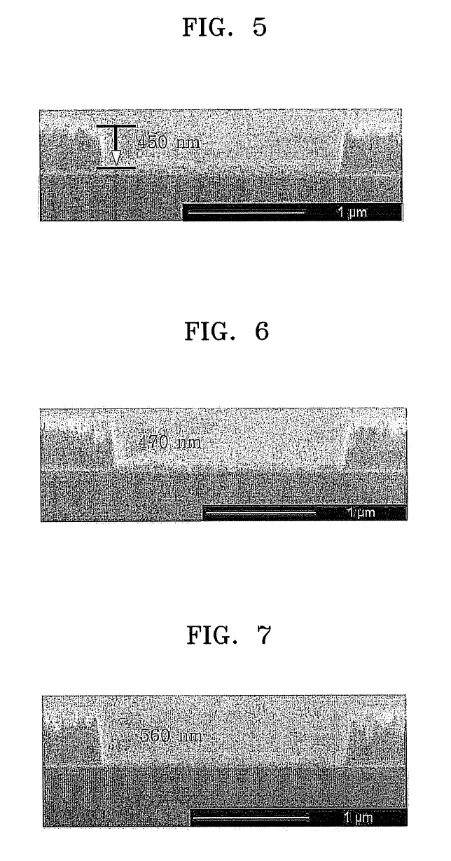

The momentum of Xe is increased by He so that during discharge, the luminance of the PDP is increased due to an increase in the molecular beam of Xe. However, the use of Xe gas in PDP discharge may cause severe plasma etching of a protective layer due to the high mobility of Xe. However, the protective layer 216 according to aspects of the present invention has high ion strength so that it can withstand the plasma etching due to the Xe. Evaluation thereof will be described in more detail in FIG. 5.

Therefore, the PDP according to aspects of the present invention includes Xe in its discharge gas in order to increase the luminance of the phosphors and He to increase the mobility of the Xe. In addition, the PDP includes the first substrate 211 that is formed of monocrystalline magnesium oxide, which is doped with a rare earth element, and the protective layer 216 that maintains a solid membrane in spite of collisions with Xe.

FIGS. 5 through 7 are images showing the results of evaluating ion strength of protective layers. FIG. 5 shows a first protective layer prepared using monocrystalline magnesium oxide that is not doped with a rare earth element. FIG. 6 shows a second protective layer prepared according to an aspect of the present invention. And FIG. 7 shows a third protective layer formed of polycrystalline magnesium oxide that is not doped with a rare earth element.

The first, second, third protective layers (of FIGS. 5, 6, and 7, respectively) were deposited by E-beam to form protective layers. Then, the results of sputtering were represented as images.

A focused ion beam (FIB) was used for sputtering, Ar⁺ was used as an ion, and etching was performed at 30 kV and 50 pA for 100 seconds.

The second protective layer (FIG. 6) is prepared by crystallization. The third protective layer (FIG. 7) is prepared using a pellet method.

Referring to FIG. 5, it can be seen that the first protective layer formed using the monocrystalline magnesium oxide that is not doped with a rare earth element is etched to a thickness of about 450 nm. Referring to FIG. 6, it can be seen that the second protective layer formed using the monocrystalline magnesium oxide that is doped with a rare earth element according to an aspect of the present invention is etched to a thickness of about 470 nm. Referring to FIG. 7, it can be seen that the third protective layer formed using the polycrystalline magnesium oxide that is not doped with a rare earth element is etched to a thickness of about 560 nm.

Therefore, it can be seen that the second protective layer according to aspects of the present invention has a solid membrane similar to the first protective layer, and has a significantly more solid membrane than the third protective layer.

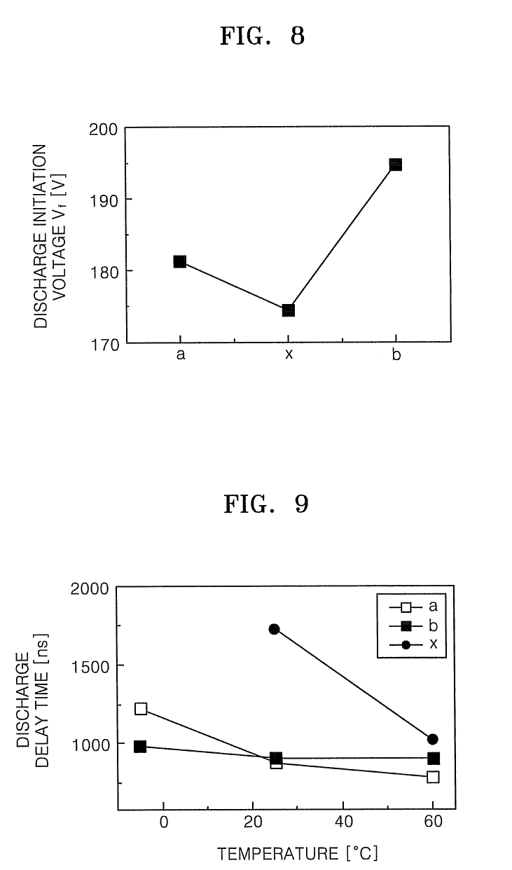

FIG. 8 is a graph showing the discharge initiation voltages of PDPs including a protective layer according to an aspect of the present invention. FIG. 9 is a graph showing the discharge delay time and temperature dependency of a PDPs including a protective layer according to an aspect of the present invention.

A discharge initiation voltage and a temperature dependency with respect to a discharge delay time of a PDP were measured by injecting a mixed discharge gas of 15% Xe, 35% He and 50% Ne into discharge cells at a pressure of 350 torr, and applying a ramp-wave voltage to drive the PDP.

In both FIGS. 8 and 9, a first protective layer (b) is formed of monocrystalline magnesium oxide that is not doped with a rare earth element, a second protective layer (x) formed of a monocrystalline magnesium oxide that is doped with a rare earth element according to aspects of the current invention, and a third protective layer (a) formed of polycrystalline magnesium oxide that is not doped with a rare earth element.

Referring to FIG. 8, a first protective layer (b) has a discharge initiation voltage of about 195 V. A third protective layer (a) has a discharge initiation voltage of about 182 V. And, a second protective layer (x) has a discharge initiation voltage of about 175 V, which is the lowest discharge initiation voltage.

Referring to FIG. 9, it can be seen that the discharge delay time of the second protective layer (x) formed according to aspects of the current invention is lower than that of the first protective layer (a) and the third protective layer (b). In addition, in terms of temperature dependency, it can be seen that the second protective layer (x) has a constant discharge delay time of about 1,000 ns at 0-60° C.

As described above, aspects of the present invention provide a protective layer of a PDP, which is deposited using monocrystalline magnesium oxide that is doped with a rare earth element as a deposition source. By using the monocrystalline magnesium oxide that is doped with a rare earth element, the PDP has a decreased discharge initiation voltage, a decreased discharge delay time, and has a constant discharge delay time regardless of temperature.

In addition, the PDP includes a protective layer deposited using monocrystalline magnesium oxide that is doped with a rare earth element as a deposition source and a mixed discharge gas of Xe and He. Therefore, the PDP can have improved luminance by increasing the momentum of Xe, and provide a protective layer having a solid membrane so that plasma etching caused by the increase in momentum of Xe can be prevented.

Accordingly, the PDP can have improved reliability and productivity.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A material for preparing a protective layer for a plasma display panel comprising:
monocrystalline magnesium oxide; and
a rare earth element,
wherein the monocrystalline magnesium oxide is doped with the rare earth element at an amount of about 2.0×10⁻⁵ to 1.0×10⁻² parts by weight per 1 part by weight of magnesium oxide.

2. The material of claim 1, wherein the monocrystalline magnesium oxide has a crystal plane of (1,0,0).

3. The material of claim 1, wherein the rare earth element is one selected from the group consisting of Sc, Y, La, Ce, Pr, Nd, Sm, Eu, Gd, Tb, Dy, Ho, Er, Tm, Yb and Lu.

4. The material of claim 1, further comprising at least one element selected from the group consisting of Al, Ca, Fe, Si, K, Na, Zr, Mn, Cr, Zn, B and Ni.

5. A method of preparing a material for a protective layer of a PDP comprising:
forming a mixed solution of magnesium oxide or a magnesium salt, a rare earth oxide or a rare earth salt, and a solvent;
calcinating the mixed solution;
crystallizing the calcinated solution; and
forming a monocrystalline magnesium oxide doped with a rare earth element.

6. The method of claim 5, wherein the magnesium salt is one selected from the group consisting of MgCO₃ and Mg(OH)₂.

7. The method of claim 5, wherein the rare earth salt is one selected from the group consisting of M(NO₃)₃, M₂(SO₄)₃ and MCl₃, in which M is the rare earth element.

8. The method of claim 5, wherein the mixed solution further comprises MgF₂ and MF₃, in which M is the rare earth element, as a fluxing agent.

9. The method of claim 5, further comprising drying the solution.

10. The method of claim 5, wherein the calcinating of the mixed solution is performed at about 400-1,000° C.

11. The method of claim 5, wherein the crystallizing of the calcinated solution is performed at about 2,000-3,000° C.

12. The method of claim 5, wherein the crystallizing the calcinated solution comprises forming a magnesium oxide composed of an amorphous region, a polycrystalline region, and a monocrystalline region; and
the forming of the monocrystalline magnesium oxide comprises extracting the monocrystalline region from the crystallized magnesium oxide.

13. The method of claim 5, wherein the rare earth element is one selected from the group consisting of Sc, Y, La, Ce, Pr, Nd, Sm, Eu, Gd, Tb, Dy, Ho, Er, Tm, Yb and Lu.

14. A protective layer of a PDP deposited using a source of a monocrystalline magnesium oxide doped with a rare earth element.

15. The protective layer of claim 14, wherein the rare earth element is one selected from the group consisting of Sc, Y, La, Ce, Pr, Nd, Sm, Eu, Gd, Tb, Dy, Ho, Er, Tm, Yb and Lu.

16. The protective layer of claim 14, wherein the monocrystalline magnesium oxide doped with a rare earth element further comprises at least one element selected from the group consisting of Al, Ca, Fe, Si, K, Na, Zr, Mn, Cr, Zn, B and Ni.

17. The protective layer of claim 14, wherein the monocrystalline magnesium oxide doped with the rare earth element is formed by calcinating and crystallizing a mixed solution of magnesium oxide or a magnesium salt, a rare earth oxide or a rare earth salt, and a solvent.

18. A plasma display panel (PDP), comprising:
a first substrate and second substrate that are separated from each other;
barrier ribs that form a plurality of discharge cells by dividing a discharge space between the first substrate and the second substrate;
a plurality of discharge electrode pairs to which a voltage is applied in order to generate discharge in the discharge cells;
a discharge gas that is injected into the discharge space;
a first dielectric layer covering the discharge electrode pairs; and
a protective layer that is formed on the first dielectric layer and formed of a monocrystalline magnesium oxide doped with a rare earth element.

19. The PDP of claim 18, wherein the monocrystalline magnesium oxide doped with the rare earth element is formed by calcinating and crystallizing a mixed solution of magnesium oxide or a magnesium salt, a rare earth oxide or a rare earth salt, and a solvent.

20. The PDP of claim 19, wherein the rare earth element is one selected from the group consisting of Sc, Y, La, Ce, Pr, Nd, Sm, Eu, Gd, Tb, Dy, Ho, Er, Tm, Yb and Lu.

21. The PDP of claim 19, wherein the monocrystalline magnesium oxide doped with a rare earth element further comprises at least one element selected from the group consisting of Al, Ca, Fe, Si, K, Na, Zr, Mn, Cr, Zn, B and Ni.

22. The PDP of claim 19, wherein the crystallization is performed at about 2,000-3,000° C.

23. The PDP of claim 18, wherein the discharge gas comprises Xe and He, or Xe, He, and Ne.

24. The PDP of claim 23, wherein the amount of Xe is 10 to 100 volume % based on the total volume of the discharge gas.

25. A material for preparing a protective layer for a plasma display panel, comprising:
monocrystalline magnesium oxide; and
a first element having an oxidation number different from the Mg in the MgO,
wherein the monocrystalline magnesium oxide is doped with the first element.

26. The material of claim 25, wherein the first element is one selected from the group consisting of Sc, Y, La, Ce, Pr, Nd, Sm, Eu, Gd, Tb, Dy, Ho, Er, Tm, Yb and Lu.

27. The material of claim 25, wherein the monocrystalline magnesium oxide is doped with the first element at an amount of about 2.0×10⁻⁵ to 1.0×10⁻² parts by weight per 1 part by weight of magnesium oxide.
